(19) United States
(12) Patent Application Publication
(10) Pub. No.: US 2016/0282673 A1
(43) Pub. Date: Sep. 29, 2016

(54) MANUFACTURING METHOD FOR LIQUID CRYSTAL DEVICE, LIQUID CRYSTAL DEVICE, AND ELECTRONIC APPARATUS

(71) Applicant: Seiko Epson Corporation, Tokyo (JP)

(72) Inventors: Koichi Takemura, Chino-shi (JP); Toshiyuki Noguchi, Fujimi-machi (JP); Nobutaka Tanaka, Shimosuwa-machi (JP)

(21) Appl. No.: 15/081,293

(22) Filed: Mar. 25, 2016

(30) Foreign Application Priority Data
Mar. 27, 2015 (JP) 2015-067302

(51) Int. Cl. G02F 1/1337

(52) U.S. Cl. CPC G02F 1/133719

(57) ABSTRACT

A manufacturing method for a liquid crystal device having a liquid crystal layer held between a pair of substrates in which an internal carbon concentration of a porous layer is 20% or more based on a surface carbon concentration of the porous layer when an alignment layer containing an organosilane compound and the porous layer disposed on a lower side of the alignment layer are formed on at least one surface, which is opposed to the liquid crystal layer, of the pair of the substrates.

### BACKGROUND

1. Technical Field

The present invention relates to an electronic apparatus, a liquid crystal device, and a manufacturing method for a liquid crystal device.

2. Related Art

Recently, it is desirable to improve light-resistance durability of a liquid crystal display element (a liquid crystal device) for display use with an increase in the use of digital signage (electronic signage).

A liquid crystal display element requires an alignment layer to control alignment of liquid crystals. As an alignment layer having superior light resistance, an alignment layer formed by chemical adsorption of an organosilane molecule onto a substrate is known (see, The Japanese Liquid Crystal Society, EKISHO, Volume 16, Number 3, 197-204 (2012)). The alignment layer containing an organosilane compound as described above is firmly attached to a substrate to form a nanometer (nm) scale ultra-thin layer. The ultra-thin alignment layer can reduce image burn-in.

Treating a surface of an inorganic alignment layer formed by an oblique vapor deposition method with a silane coupling agent (an organosilane compound) has been proposed (see, JP-A-2007-127757). The structure can prevent light-deterioration and improve light resistance at the interface between a liquid crystal layer and an alignment layer.

The pore size of the inorganic alignment layer is as small as several nanometers. It is thus difficult to treat the inorganic alignment layer throughout the inner surface of the pore because it is difficult for an organosilane compound to permeate into the pores (see, Japanese Patent No. 4,631,334, Japanese Patent No. 4,670,452, JP-A-2007-33966, and JP-A-2000-47211).

Patent documents of Japanese Patent No. 4,631,334, Japanese Patent No. 4,670,452, JP-A-2007-33966, and JP-A-2000-47211 disclose that an organosilane compound or an alcohol is able to permeate into the pores. The patent documents do not disclose that the organosilane compound or the alcohol actually permeates into the inorganic alignment layer (a porous layer). Existing methods may thus not enable an organosilane compound to sufficiently permeate into a porous layer.

### SUMMARY

An advantage of some aspects of the invention is to enable further improvement of the light-resistance durability of a liquid crystal device by forming an alignment layer having a porous layer in which the porous layer is sufficiently permeated by an organosilane compound. An advantage of some aspects of the invention is thus to provide a liquid crystal device, an electronic apparatus, and a manufacturing method for a liquid crystal device, which enables improvement of the light-resistance durability.

A manufacturing method for a liquid crystal device of one aspect of the invention is a manufacturing method for a liquid crystal device having a liquid crystal layer held between a pair of substrates in which an internal carbon concentration of a porous layer is 20% or more based on a surface carbon concentration of the porous layer when an alignment layer containing an organosilane compound and the porous layer disposed on a lower side of the alignment layer are formed on at least one surface, which is opposed to the liquid crystal layer, of the pair of the substrates.

The manufacturing method enables to find the relative ratio of permeation of the organosilane compound into the porous layer to be determined by calculating a ratio of the internal carbon concentration of the porous layer to the surface carbon concentration of the porous layer. When an internal carbon concentration of a porous layer is 20% or more (more preferably, 50% or more) based on the surface carbon concentration of the porous layer, the alignment layer having the porous layer in which the organosilane compound sufficiently permeates into the porous layer can be formed. The manufacturing method can thus further improve light-resistance durability of the liquid crystal device.

In the manufacturing method, the alignment layer may be formed by applying a coating liquid containing the organosilane compound onto the surface of the porous layer, forming the coating film by allowing the coating liquid to permeate into the porous layer by capillarity, and baking the coating film.

The manufacturing method enables a coating liquid containing the organosilane compound applied onto the surface of the porous layer to permeate into the porous layer by capillarity. The organosilane compound can thus sufficiently permeate into the porous layer.

In the manufacturing method, an alignment layer may also be formed by vapor depositing the organosilane compound onto the surface of the porous layer.

The manufacturing method enables the vaporized organosilane compound to permeate into the porous layer. The organosilane compound can thus sufficiently permeate into the porous layer.

A manufacturing method for a liquid crystal device of one aspect of the invention is a manufacturing method for a liquid crystal device having a liquid crystal layer held between a pair of substrates in which an internal fluorine concentration of a porous layer is 20% or more based on a surface fluorine concentration of the porous layer when an alignment layer containing a fluorine-containing organosilane compound and the porous layer disposed on a lower side of the alignment layer are formed on at least one surface, which is opposed to the liquid crystal layer, of the pair of the substrates.

The manufacturing method enables the relative ratio of permeation of the fluorine-containing organosilane compound into the porous layer to be determined by calculating the ratio of the internal fluorine concentration of the porous layer to the surface fluorine concentration of the porous layer. When the internal fluorine concentration of a porous layer is 20% or more (more preferably, 50% or more) based on the surface fluorine concentration of the porous layer, the alignment layer having the porous layer in which the fluorine-containing organosilane compound sufficiently permeates into the porous layer can be formed. The manufacturing method thus enables further improvement of the light-resistance durability of a liquid crystal device.

In the manufacturing method, the alignment layer may be formed by applying a coating liquid containing the fluorine-containing organosilane compound onto the surface of the porous layer, forming the coating film by allowing the coating liquid to permeate into the porous layer by capillarity, and baking the coating film.

The manufacturing method enables a coating liquid containing the fluorine-containing organosilane compound applied onto the surface of the porous layer to permeate into the porous layer by capillarity. The fluorine-containing organosilane compound can thus sufficiently permeate into the porous layer.

In the manufacturing method, the alignment layer may also be formed by vapor depositing the fluorine-containing organosilane compound onto the surface of the porous layer.

The manufacturing method enables the vaporized fluorine-containing organosilane compound to permeate into the porous layer. The fluorine-containing organosilane compound can thus sufficiently permeate into the porous layer.

In the manufacturing method, average pore size of the pores is preferably 2 to 50 nm.

The manufacturing method enables the organosilane compound or the fluorine-containing organosilane compound to permeate into the porous layer.

In the manufacturing method, a column-shaped inorganic oxide film having pores between columnar structures formed by an oblique vapor deposition method is preferably formed as the porous layer.

The manufacturing method enables liquid crystal molecules of the liquid crystal layer to align along the columnar structure because the columnar structure is formed oblique to the plane on which the inorganic alignment layer is formed.

In the manufacturing method, an inorganic oxide film selected from SiO₂, SnO₂, GeO₂, ZrO₂, TiO₂, and Al₂O₃ is preferably formed as the porous layer.

The manufacturing method enables the organosilane compound or the fluorine-containing organosilane compound to fix firmly to the inorganic oxide film.

A liquid crystal device of one aspect of the invention is a liquid crystal device having a liquid crystal layer held between a pair of substrates, including an alignment layer containing an organosilane compound and a porous layer disposed on a lower side of the alignment layer placed on at least one surface, which is opposed to the liquid crystal layer, of the pair of the substrates, in which the alignment layer covers the surface of the porous layer in a state where the alignment layer permeates into the porous layer, and an internal carbon concentration of the porous layer is 20% or more based on a surface carbon concentration of the porous layer.

The configuration can thus further improve light-resistance durability because the configuration includes the alignment layer containing the organosilane compound, which sufficiently permeates into a porous layer.

A liquid crystal device of one aspect of the invention is a liquid crystal device having a liquid crystal layer held between a pair of substrates, including an alignment layer containing a fluorine-containing organosilane compound and a porous layer disposed on a lower side of the alignment layer placed on at least one surface, which is opposed to the liquid crystal layer, of the pair of the substrates, in which the alignment layer is covering the surface of the porous layer in a state where the alignment layer permeates into the porous layer, and the internal fluorine concentration of the porous layer is 20% or more based on a surface fluorine concentration of the porous layer.

The configuration can thus further improve light-resistance durability because the configuration includes the alignment layer containing the fluorine-containing organosilane compound, which sufficiently permeates into the porous layer.

An electronic apparatus of one aspect of the invention includes a liquid crystal device manufactured by any of the methods or includes any of the liquid crystal devices.

The configuration can thus provide the electronic apparatus including the liquid crystal device with superior light-resistance durability.

### BRIEF DESCRIPTION OF THE DRAWINGS

The invention will be described with reference to the accompanying drawings, wherein like numbers reference like elements.

FIG. 1 is an equivalent circuit diagram illustrating an electrical configuration of a liquid crystal device of one embodiment of the invention.

FIG. 2 is a plan view illustrating a configuration of pixels on a TFT array substrate included in the liquid crystal device illustrated in FIG. 1.

FIG. 3 is a cross-sectional view illustrating a structure of the liquid crystal device illustrated in FIG. 1.

FIG. 4 is a cross-sectional view illustrating a structure of a pixel region of the liquid crystal device illustrated in FIG. 1.

FIG. 5 is a cross-sectional schematic view illustrating a structure of a porous layer and an alignment layer of the liquid crystal device illustrated in FIG. 1.

FIG. 6 is a flow chart illustrating steps of forming an alignment layer by processing including a liquid process.

FIG. 7 is a flow chart illustrating steps of forming an alignment layer by processing including a vapor process.

FIG. 8A is an oblique view illustrating an example of electronic apparatus of one embodiment of the invention.

FIG. 8B is an oblique view illustrating an example of electronic apparatus of one embodiment of the invention.

FIG. 8C is an oblique view illustrating an example of electronic apparatus of one embodiment of the invention.

FIG. 9 is a schematic view illustrating an example of a projection type liquid crystal display device of one embodiment of the invention.

FIG. 10 is a graph illustrating the relationship between sputtering time and composition ratio of metal and oxygen in Examples.

### DESCRIPTION OF EXEMPLARY EMBODIMENTS

Embodiments of the invention will hereinafter be described with reference to the drawings. The dimensions of layers or members in each Figure are not to scale to make them recognizable.

### Liquid Crystal Device

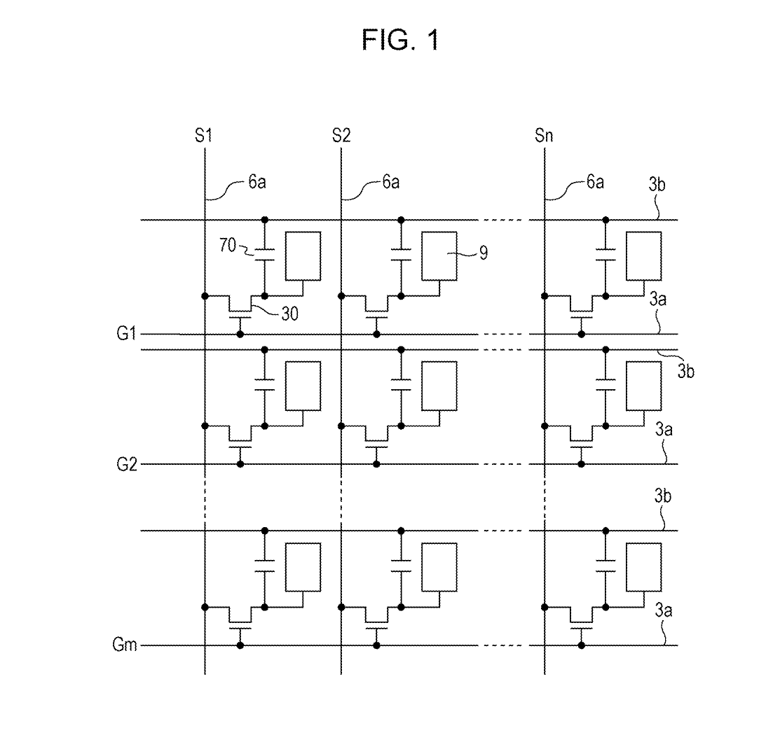

A liquid crystal device of one embodiment of the invention will be described with reference to FIGS. 1 to 4.

A liquid crystal device of the embodiment is an active-matrix transmissive liquid crystal device using a TFT (Thin-Film Transistor) element as a switching element.

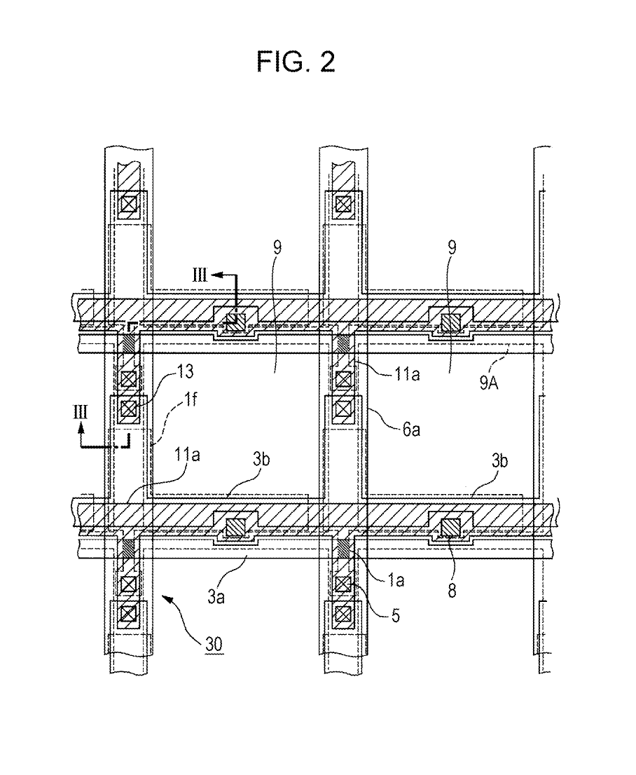

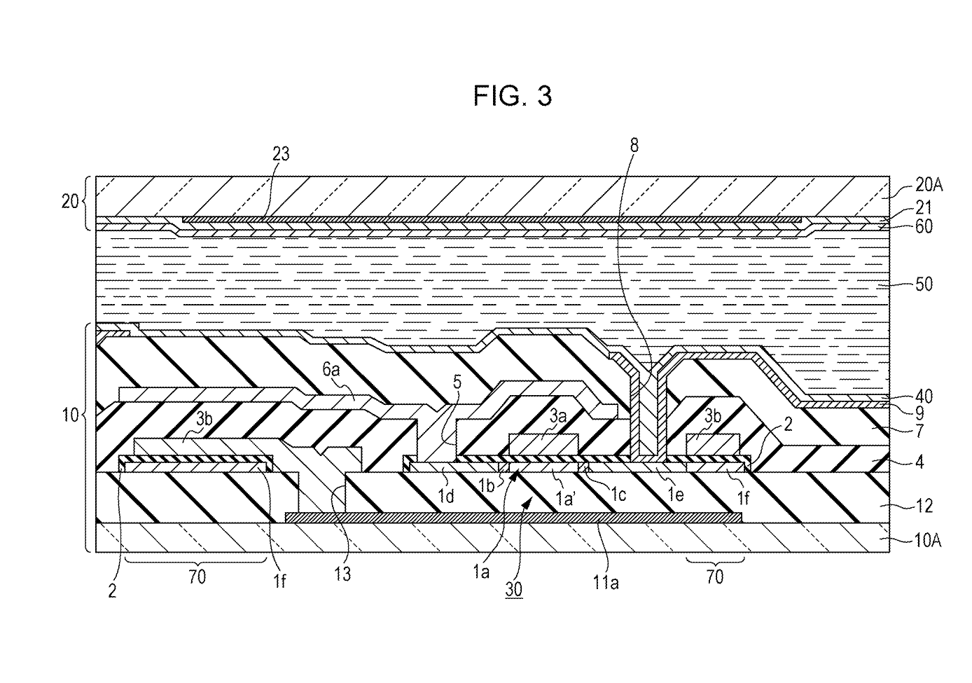

FIG. 1 is an equivalent circuit diagram illustrating an electrical configuration including switching elements, signal lines, or the like in a plurality of pixels arranged in a matrix constituting an image display region of a transmissive liquid crystal device of the embodiment. FIG. 2 is a plan view of a configuration of a plurality of pixels adjacent to each other on the TFT array substrate where data lines, scanning lines, and pixel electrodes are formed. FIG. 3 is a cross-sectional view, taken along the line III-III of FIG. 2, illustrating a structure of an element region in a transmissive liquid crystal device of the embodiment. FIG. 4 is a schematic cross-sectional view illustrating a structure of a plurality of pixel regions in a transmissive liquid crystal device of the embodiment. FIGS. 3 and 4 depict views where an incident light side is above the plane of the paper and a viewing side (an observer side) is behind the plane of the paper. In FIG. 4, some constituents such as switching elements are omitted for clarity of illustration.

As illustrated in FIG. 1, a transmissive liquid crystal device of the embodiment includes a plurality of pixels arranged in a matrix constituting an image display region. Each pixel includes a pixel electrode 9 and a TFT element 30, which is a switching element for controlling electric current to the pixel electrode 9. Data lines 6a, to which image signals are supplied, are electrically connected to sources of the TFT elements 30. Image signals S1, S2, . . . , Sn to be provided to data lines 6a may be sequentially supplied in a line in this order or may be supplied in groups to a plurality of the data lines 6a adjacent to each other.

Scanning lines 3a are electrically connected to gates of the TFT elements 30, and scanning signals G1, G2, . . . , Gm are sequentially applied in a line to a plurality of the scanning lines 3a in a pulse at a predetermined timing. The pixel electrodes 9 are electrically connected to drains of the TFT elements 30, and the image signals S1, S2, . . . , Sn supplied from the data lines 6a are written at a predetermined timing by operating the TFT elements 30 as the switching elements for a certain period of time.

The image signals S1, S2, . . . , Sn having the predetermined level written on the liquid crystal via the pixel electrodes 9 are stored together with the below-described common electrodes for a certain period of time. The liquid crystal can modulate light and provide a gradation display because the liquid crystal varies alignment or the order of molecular association according to an applied voltage level. Storage capacitors 70 are provided in parallel with liquid crystal capacitors formed between the pixel electrodes 9 and common electrodes in order to prevent the stored image signals from leaking.

As illustrated in FIG. 2, a transmissive liquid crystal device of the embodiment includes a plurality of the rectangular pixel electrodes 9 (their outlines are shown as dot-line portions 9A) formed in a matrix on the TFT array substrate. The rectangular pixel electrodes 9 include a transparent electrical conducting material such as indium tin oxide (hereinafter abbreviated as “ITO”). The data lines 6a, the scanning lines 3a, and the capacitor lines 3b are provided along the vertical and horizontal boundaries of each pixel electrode 9. In the embodiment, the regions where the data lines 6a, the scanning lines 3a, and the capacitor lines 3b are provided so as to surround each pixel electrode 9 and each pixel electrode 9 are pixels. The structure enables each pixel arranged in a matrix to display independently.

The data lines 6a are electrically connected to the below-described source regions of the semiconductor layers 1a, which constitute a TFT element 30 and include, for example, a polysilicon film, via a contact hole 5. The pixel electrodes 9 are electrically connected to the below-described drain regions of the semiconductor layers 1a via a contact hole 8. The scanning lines 3a are disposed opposite to the below-described channel regions (the hatched region in FIG. 2) of the semiconductor layers 1a. The scanning lines 3a, which are disposed opposite to the channel regions, function as gate electrodes.

The capacitor lines 3b include main line portions (i.e., first regions formed along the scanning lines 3a in plan view) that extend substantially straight along the scanning lines 3a and projecting portions (i.e., second regions extending along the data lines 6a in plan view) that protrude from the intersections with the data lines 6a to preceding stages along the data lines 6a (upward in FIG. 2). A plurality of the first light-shielding films 11a are formed in the hatched region in FIG. 2

As illustrated in FIGS. 3 and 4, a transmissive liquid crystal device of the embodiment includes a liquid crystal layer 50 held between a TFT array substrate 10 (a substrate for a liquid crystal device) and an opposing substrate 20 (a substrate for a liquid crystal device) disposed opposite to the TFT array substrate. The liquid crystal layer 50 includes negative dielectric anisotropy liquid crystal, which provides vertical alignment in an initial alignment state. A transmissive liquid crystal device of the embodiment is a display device of vertical alignment mode.

The TFT array substrate 10 includes primarily a main substrate 10A containing a transparent material, for example, quartz, or the like, and the pixel electrode 9 and an alignment layer 40 formed upon the surface facing toward the liquid crystal layer 50. The opposing substrate 20 includes primarily a main substrate 20A containing a transparent material, for example, glass, quartz, or the like, and a common electrode 21 and an alignment layer 60 formed on the surface facing toward the liquid crystal layer 50. In the TFT array substrate 10, a surface, which is facing toward the liquid crystal layer 50, of the main substrate 10A (the inner surface) includes the pixel electrode 9 and a pixel switching TFT element 30 adjacent to each pixel electrode 9 for controlling the switching of the pixel electrodes 9.

The pixel switching TFT element 30 includes an LDD (Lightly Doped Drain) structure. Specifically, the pixel switching TFT element 30 includes the scanning line 3a; the channel regions 1a′ of the semiconductor layer 1a in which a channel is formed by an electric field from the scanning line 3a, a gate insulating layer 2 for insulating the scanning line 3a from the semiconductor layer 1a, the data line 6a, a lightly doped source region 1b and a lightly doped drain region 1c of the semiconductor layer 1a, and a heavily doped source region 1d and a heavily doped drain region 1e of the semiconductor layer 1a.

A second interlayer insulating film 4, through which the contact hole 5 communicating with the heavily doped source region 1d and the contact hole 8 communicating with the heavily doped drain region 1e are made, is formed on the main substrate 10A including the scanning line 3a and the gate insulating layer 2. In other words, the data line 6a is electrically connected to a heavily doped source region 1d via the contact hole 5 penetrating the second interlayer insulating film 4.

A third interlayer insulating film 7, through which the contact hole 8 which is in contact with the heavily doped drain region 1e is made, is formed on the main substrate 10A including the data line 6a and the second interlayer insulating film 4. In other words, the heavily doped drain region 1e is electrically connected to the pixel electrodes 9 via the contact hole 8 penetrating the second interlayer insulating film 4 and the third interlayer insulating film 7.

In the embodiment, the storage capacitor 70 is formed in the following manner: the gate insulating layer 2 is elongated from a position opposed to the scanning line 3a and is used as a dielectric film, a semiconductor film 1a is elongated and used as a first storage capacitor electrode 1f, and a part of the capacitor line 3b opposed thereto is used as a second storage capacitor electrode.

A first light-shielding film 11a is formed on a region, where each pixel switching TFT element 30 is formed, of a surface facing toward the liquid crystal layer 50 of the main substrate 10A in the TFT array substrate 10 (the inner surface). The first light-shielding film 11a prevents returned light from entering at least the channel regions 1a′ and the lightly doped source region 1b and drain region 1c of the semiconductor layer 1a as a result of the light passed through the TFT array substrate 10 being reflected at the lower surface of the TFT array substrate 10 in the figure (interface between the TFT array substrate 10 and air) and returned to the liquid crystal layer 50 side.

A first interlayer insulating film 12 is formed between the first light-shielding film 11a and the pixel switching TFT element 30 to electrically insulate the semiconductor layer 1a constituting the pixel switching TFT element 30 from the first light-shielding film 11a.

The first light-shielding film 11a is formed in the TFT array substrate 10. The first light-shielding film 11a is electrically connected to the preceding or following capacitor line 3b via a contact hole 13.

The alignment layer 40 is formed on the side facing toward the liquid crystal layer 50 of the TFT array substrate 10, i.e., on the pixel electrodes 9 and the third interlayer insulating film 7. The alignment layer 40 controls alignment of liquid crystal molecules in the liquid crystal layer 50 when no voltage is applied.

In the opposing substrate 20, a surface facing toward the liquid crystal layer 50 of the main substrate 20A (the surface) includes a second light-shielding film 23. The second light-shielding film 23 prevents incident light from entering the channel regions 1a′ of the semiconductor layer 1a on the pixel switching TFT element 30, the lightly doped source region 1b and the lightly doped drain region 1c by covering a region opposed to the forming region of the data line 6a, the scanning line 3a, and the pixel switching TFT element 30, i.e., a region excluding an aperture region of each pixel unit.

The common electrode 21, which includes, for example, ITO or the like, is formed across substantially the whole surface facing toward the liquid crystal layer 50 of the main substrate 20A where the second light-shielding film 23 is formed. The alignment layer 60 is formed on the side facing toward the liquid crystal layer 50 of common electrode 21. The alignment layer 60 controls alignment of liquid crystal molecules in the liquid crystal layer 50 when no voltage is applied.

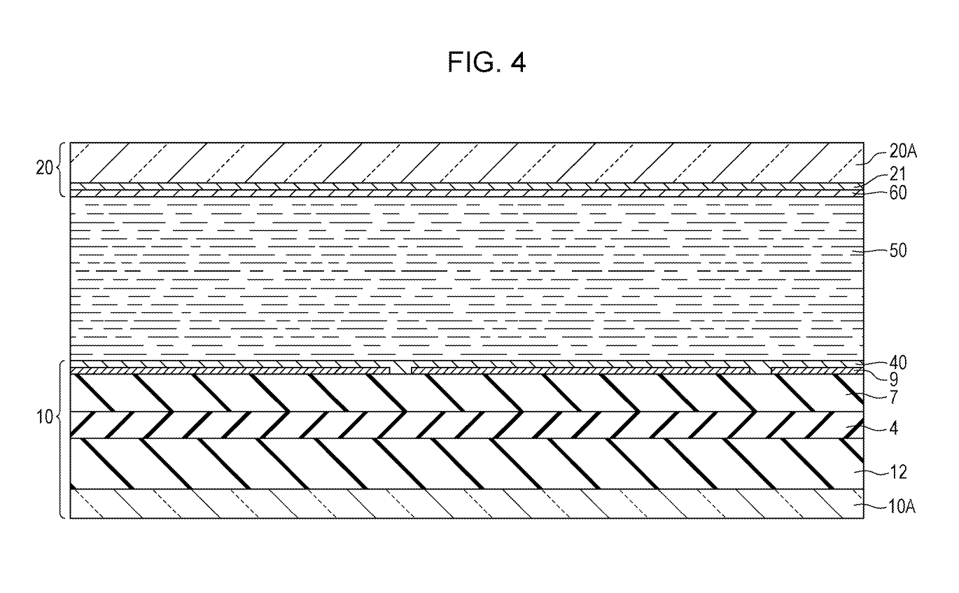

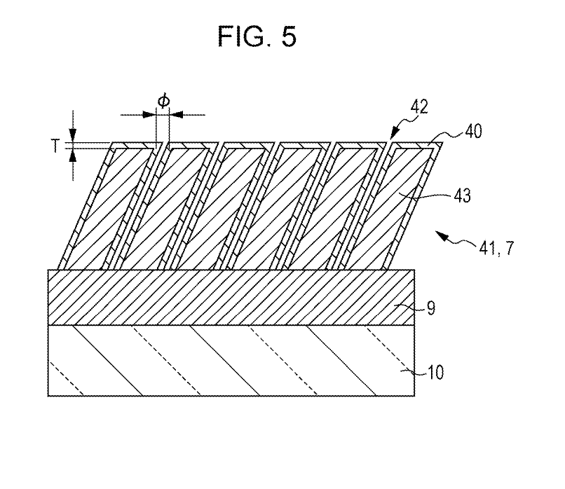

Structures of the alignment layer 40 (60) will be described with reference to FIG. 5. FIG. 5 is a cross-sectional schematic view illustrating a structure of the alignment layer 40 (60). The embodiment illustrates, by way of example, a structure in which the alignment layer 40 of the TFT array substrate 10 and the alignment layer 60 of the opposing substrate 20 have a mutually identical structure. The alignment layer 40 is thus described as an example in FIG. 5.

A liquid crystal device of the embodiment includes the alignment layer 40 containing an organosilane compound and a porous layer 41 disposed on the lower side of the alignment layer 40 on the surface facing toward the liquid crystal layer 50 of the TFT array substrate 10 as illustrated in FIG. 5.

The porous layer 41 includes an inorganic oxide having a plurality of pores 42. The inorganic oxide includes, for example, SiO₂, SnO₂, GeO₂, ZrO₂, TiO₂, and Al₂O₃. The porous layer 41 forms the third interlayer insulating film 7 on the side of the TFT array substrate 10.

The porous layer 41 includes a column-shaped inorganic oxide film in which pores (gaps) 42 are formed between columnar structures (hereinafter referred to as “columns”) 43 by an oblique vapor deposition method. In a column-shaped inorganic oxide film (an oblique vapor deposition film), liquid crystal molecules of the liquid crystal layer 50 can be aligned along the column 43 because the column 43 is obliquely formed.

The alignment layer 40 is formed on the surface of the porous layer 41 at a thickness T which is thinner than the pore size φ of the pores 42 in the porous layer 41 with the organosilane compound being permeated into the porous layer 41.

The pore size φ of pores 42 is preferably 2 to 50 nm on average to provide sufficient permeability so that the below-described organosilane compound permeates into the porous layer 41. When the pore size φ is within the range, the pores 42 do not exert a harmful effect upon alignment control of the liquid crystal layer 50 by the alignment layer 40. The pore size φ of pores 42 can be measured by, for example, scanning electron microscopy (SEM), transmission electron microscopy (TEM), X-ray small angle scattering (SAXS), or the like. Specific surface area and pore-size distribution of the porous layer 41 can be measured by gas adsorption.

The thickness T of the alignment layer 40 is preferably 1 to 10 nm on average for forming the alignment layer 40 containing the organosilane compound as an ultra-thin layer. The resultant ultra-thin alignment layer 40 can prevent image burn-in of the liquid crystal device. The thickness T of the alignment layer 40 can be measured by, for example, X-ray photoelectron spectrometry (XPS), X-ray reflectivity (XRR), ellipsometry, scanning electron microscopy (SEM), transmission electron microscopy (TEM), or the like.

The alignment layer 40 is formed to cover the surface of the porous layer 41 which has been permeated. In the embodiment, an internal carbon concentration of the porous layer 41 is preferably 20% or more, or more preferably 50% or more based on a surface carbon concentration of the porous layer 41.

The organosilane compound includes an alkyl silane molecule. The alkyl silane molecule binds (by hydrogen bonding) to a surface of the porous layer 41 (inorganic oxide) and then undergoes a dehydration condensation reaction to form a strong covalent bond with a surface of the porous layer 41 (inorganic oxide). The surface carbon concentration of the porous layer 41 is thereby increased. The internal carbon concentration of the porous layer 41 is also increased by permeation of an alkyl silane molecule into the porous layer 41.

Although the upper limit of the ratio of an internal carbon concentration of the porous layer 41 to a surface carbon concentration of the porous layer 41 is not specifically defined, the ratio of the alignment layer 40 permeated into the porous layer 41 can thus be close to 100%.

An alkyl silane molecule represented by following Formula (1):

Rₐ—S—X₄₋ₐ (1)

wherein “a” represents an integer of 0 to 3;

can be used as the organosilane compound.

In Formula (1) above, R represents an organic group, for example, —C₆H₅, —CₙH₂ₙ₊₁, or the like. X represents a hydrolytic group, for example, —Cl, —OCH₃, —OC₂H₅, —OC₃H₇, or the like.

When an alkyl silane molecule having n=1 to 20 (more preferably, n=1 to 10) is used as the organosilane compound, a high coating density can be provided to improve light resistance. When a saturated hydrocarbon is used for R, degradation of R can be prevented to improve light resistance.

In addition to the above-described organosilane compound, a fluorine-containing organosilane compound of which hydrogens of the alkyl silane molecule are at least partially substituted with fluorine can be used as the alignment layer 40 of the embodiment. When a fluorine-containing organic group such as —CₙF₂ₙ₊₁ is used for R in Formula (1), the vertical alignment capability of the liquid crystal layer 50 can be improved.

When the fluorine-containing organosilane compound is used for the alignment layer 40, an internal fluorine concentration of the porous layer 41 is 20% or more, or more preferably 50% or more based on the surface fluorine concentration of the porous layer 41.

A surface carbon concentration or a surface fluorine concentration of the porous layer 41 can be measured by X-ray photoelectron spectroscopy (ESCA: Electron Spectroscopy for Chemical Analysis). An internal carbon concentration or an internal fluorine concentration of the porous layer 41 can be measured by ESCA using Ar ion sputtering or dynamic mode secondary ion mass spectroscopy (D-SIMS: Dynamic-Secondary Ion Mass Spectrometry).

It is difficult to determine an absolute value of the surface carbon concentration and the internal carbon concentration or the surface fluorine concentration and the internal fluorine concentration of the porous layer 41 by these analysis methods. However, the methods enable the relative ratio of the organosilane compound or the fluorine-containing organosilane compound permeated into the porous layer 41 to be determined by specifying a ratio of the internal carbon concentration or the internal fluorine concentration of the porous layer 41 to the surface carbon concentration or the surface fluorine concentration of the porous layer 41.

In the liquid crystal device of the embodiment, when the internal carbon concentration or the internal fluorine concentration of the porous layer 41 is 20% or more (more preferably, 50% or more) based on the surface carbon concentration or the surface fluorine concentration of the porous layer 41, the alignment layer 40 having the porous layer 41 in which the organosilane compound or the fluorine-containing organosilane compound sufficiently permeates into the porous layer 41 can be provided.

The liquid crystal device of the embodiment can thus further improve light-resistance durability because the liquid crystal device includes the alignment layer 40 containing the organosilane compound or the fluorine-containing organosilane compound, which sufficiently permeates into the porous layer 41, as described above.

### Manufacturing Method for Liquid Crystal Devices

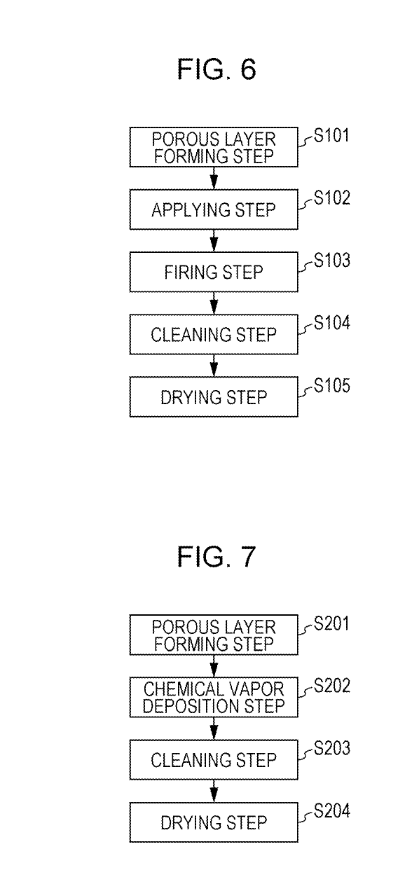

A manufacturing method for liquid crystal devices of the embodiments will be described with reference to flow charts illustrated in FIG. 6 and FIG. 7. FIG. 6 and FIG. 7 show specific flow charts of the manufacturing method illustrating steps of forming the alignment layer 40 on the surface of the porous layer 41. FIG. 6 illustrates forming the alignment layer 40 by processing including a liquid process. FIG. 7 illustrates forming the alignment layer 40 by processing including a vapor process.

When manufacturing the liquid crystal device of the embodiment, the TFT array substrate 10 is initially manufactured. Specifically, the transparent main substrate 10A including glass or the like is provided, and the above-described first light-shielding film 11a, the first interlayer insulating film 12, the semiconductor layer 1a, the lines 3a, 3b, and 6a, the insulating layer 4 and 7, the pixel electrodes 9, and the like are formed on the main substrate 10A by publicly known methods. The alignment layer 40 is then formed on the third interlayer insulating film 7 including the pixel electrodes 9 to provide the TFT array substrate 10.

The above-described opposing substrate 20 is prepared in addition to the TFT array substrate 10. Specifically, a transparent main substrate 20A including glass or the like is provided. The second light-shielding film 23 and common electrode 21 are then formed on the surface of the main substrate 20A by the same method as forming the TFT array substrate 10, and the alignment layer 60 is formed by the same method as forming the alignment layer 40 to provide the opposing substrate 20.

The TFT array substrate 10 and the opposing substrate 20 are stuck together via a sealing agent. A negative dielectric anisotropy liquid crystal is introduced through a liquid crystal inlet formed in the sealing agent to provide a liquid crystal panel, and predetermined lines are then connected. A liquid crystal device of the embodiment can thus be manufactured.

In the manufacturing method of the embodiment, the internal carbon concentration or the internal fluorine concentration of the porous layer is made to be 20% or more based on the surface carbon concentration or the surface fluorine concentration of the porous layer by permeation of the organosilane compound or the fluorine-containing organosilane compound into the porous layer 41 when the alignment layer 40 is formed. More preferably, the concentration is made to be 50% or more.

A liquid deposition method (a liquid process) and a vapor deposition method (a vapor process) are used for permeation of the organosilane compound or the fluorine-containing organosilane compound into the porous layer 41.

Using a liquid deposition method, the alignment layer 40 can be formed by applying a coating liquid containing the organosilane compound or the fluorine-containing organosilane compound onto the surface of the porous layer 41, forming the coating film by allowing the coating liquid to permeate into the porous layer 41 by capillarity, and baking the coating film. Using a vapor deposition method, the alignment layer 40 can be formed by vapor depositing the organosilane compound or the fluorine-containing organosilane compound onto the surface of the porous layer 41.

A method for forming the alignment layer 40 by a liquid process will be specifically described with reference to a flow chart illustrated in FIG. 6.

When the alignment layer 40 is formed by a liquid process, the alignment layer 40 can be formed by undergoing the porous layer forming step S101 followed by the applying step S102, the baking step S103, the cleaning step S104, and the drying step S105 as illustrated in FIG. 6.

In the porous layer forming step S101, an inorganic oxide such as SiO₂, SnO₂, GeO₂, ZrO₂, TiO₂, or Al₂O₃ is vapor deposited onto the surface of the substrate from an oblique direction by using the above-described oblique vapor deposition method under reduced pressure (10⁻² to 10⁻³ Pa). The column-shaped inorganic oxide film having the pores 42 between the columns 43 can thus be formed.

In the applying step S102, a coating liquid including the organosilane compound or the fluorine-containing organosilane compound is applied onto the surface of the porous layer 41 by, for example, spin coating, dip coating, ink jet printing, or flexography. The concentration of the organosilane compound or the fluorine-containing organosilane compound included in the coating liquid is preferably 0.1 to 10% by mass.

A hydrolysis reaction is accelerated by acid added to the coating liquid, and thus silanization (fixation reaction) of a porous layer (an inorganic oxide film) 41 is promoted. The acid used includes, for example, a carboxylic acid such as acetic acid, formic acid, oxalic acid, or the like or a sulfonic acid such as, methane sulfonate, ethane sulfonic acid, benzene sulfonic acid, or the like.

In a liquid process, capillarity is used for permeation of a coating liquid into the porous layer 41. The capillarity is explained by the Lucas-Washburn Equation (L-W equation) represented by the following Equation (2):

I=(rγ cos θt/2η)^{1/2} (2)

wherein, I represents permeation depth, r represents capillary radius, γ represents surface tension of the liquid, θ represents contact angle (=0°), η represents viscosity, and t represents time.

In the liquid process, a coating liquid can permeate into the porous layer 41 by using a method represented by the steps [1] to [3] shown below.

[1] Using a low-viscosity coating liquid (specifically, 5 cP or less)

[2] Allowing to stand after application

[3] During Step [2], more preferably, heating as long as the solvent is not evaporated (specifically 30 to 50° C.) leads to lowered viscosity

A larger pore size of pores 42 in the porous layer 41 leads to greater capillarity. The larger pore size thus contributes to the coating liquid to permeate into the porous layer 41. The larger pore size of pores 42 in the porous layer 41 can be achieved by using a method represented by the steps <1> to <3> shown below.

<1> Decreasing the vapor deposition angle with the surface of the substrate (laying) during oblique deposition

<2> Increasing pressure (using a low vacuum) during vapor deposition in oblique deposition

<3> Wet etching the porous layer

In the baking step S103, the TFT array substrate 10 is heated after application of the coating liquid. The heating temperature is preferably 60 to 200° C. During the heating, dehydration condensation reaction progresses to fix the organosilane compound or the fluorine-containing organosilane compound to the porous layer 41. The alignment layer 40 is thus formed to cover the surface of the porous layer 41 which has been permeated.

In the cleaning step S104, the remaining organosilane compound or the remaining fluorine-containing organosilane compound, which is not fixed to the porous layer 41, is removed by cleaning the TFT array substrate 10 after baking. The cleaning method used includes immersion cleaning, oscillation cleaning, ultrasonic cleaning, spin cleaning, spray cleaning, shower cleaning, jet cleaning, and so forth. Display defects such as image burn-in or flicker of a liquid crystal device can thus be reduced.

In the drying step S105, the TFT array substrate 10 is dried by leaving the cleaned TFT array substrate 10 under heating conditions. The TFT array substrate 10 may also be left under reduced pressure in the drying step S105. The TFT array substrate 10 may further be left under heating conditions and reduced pressure. The residual solvent after cleaning of the TFT array substrate 10 is thus removed.

A method for forming the alignment layer 40 by a vapor process will be specifically described with reference to a flow chart illustrated in FIG. 7.

When the alignment layer 40 is formed by a vapor process, the alignment layer 40 can be formed by undergoing the porous layer forming step S201, followed by the chemical vapor deposition step S202, the cleaning step 203, and the drying step S204 as illustrated in FIG. 7.

Among the steps, steps S201, 203, and 204, which are the steps except for the chemical vapor deposition step S202, can be carried out by the same method as forming the alignment layer 40 illustrated in FIG. 6 by a liquid process, and thus methods for the steps of S201, 203, and 204 are not described here.

In the chemical vapor deposition step S202, the organosilane compound or the fluorine-containing organosilane compound is vapor deposited (fixed) onto the surface of the porous layer 41. Specifically, a container, which contains the liquid organosilane compound or the liquid fluorine-containing organosilane compound, and the TFT array substrate 10 including the porous layer 41 are disposed in a hermetically sealed chamber. The container is then heated to evaporate the organosilane compound or the fluorine-containing organosilane compound. A high internal chamber temperature (specifically, 100 to 200° C.) is preferred.

When a large amount of the organosilane compound or the fluorine-containing organosilane compound is in the container, mutual polymerization of the organosilane molecules is accelerated because it is a high-concentration process. The resultant polymer provides a cap-like function in proximity to the surface of the porous layer 41. The organosilane compound or the fluorine-containing organosilane compound is thus unable to sufficiently permeate into the porous layer 41.

In light of the above, when the alignment layer 40 is formed by a vapor process, the deposition process is carried out using a low-concentration organosilane compound or a low-concentration fluorine-containing organosilane compound over a long duration under reduced pressure in the chamber. Specifically, the deposition process is carried out under a partial pressure of the organosilane compound or the fluorine-containing organosilane compound being 1 to 100 Pa for 40 to 4000 minutes of processing time. The reaction rate of the porous layer and silane molecule is first-order with respect to the concentration of silane molecules, and thus, for example, 1/10 of the concentration requires approximately 10-times processing time.

As described above, in the manufacturing method of the embodiment, it is possible to form the alignment layer 40 having the internal carbon concentration or the internal fluorine concentration of the porous layer to be 20% or more (more preferably, 50% or more) based on the surface carbon concentration or the surface fluorine concentration of the porous layer 41 by permeation of the organosilane compound or the fluorine-containing organosilane compound into the porous layer 41.

In the manufacturing method of the embodiment, the alignment layer 40 having the porous layer 41 in which the organosilane compound or the fluorine-containing organosilane compound sufficiently permeates into the porous layer 41 can thus be formed. The manufacturing method can thus further improve light-resistance durability of the liquid crystal device.

The invention is not limited to the above-described embodiments, and various changes are possible without departing from the scope of the invention. In the embodiment, for example, only an active matrix liquid crystal device using a TFT element is described, however, the invention is not limited to the above embodiment. The invention can also be applied to, for example, an active matrix liquid crystal device using TFD (Thin-Film Diode) element, a passive matrix liquid crystal device, or the like. In the embodiment, only a transmissive liquid crystal device is described, however, the invention is not limited to the above embodiment. The invention can also be applied to a reflective liquid crystal device or a transreflective liquid crystal device. The invention can thus be applied to any liquid crystal devices having any structures.

### Electronic Apparatus

Examples of electronic apparatuses including liquid crystal devices of the above-described embodiments will hereinafter be described.

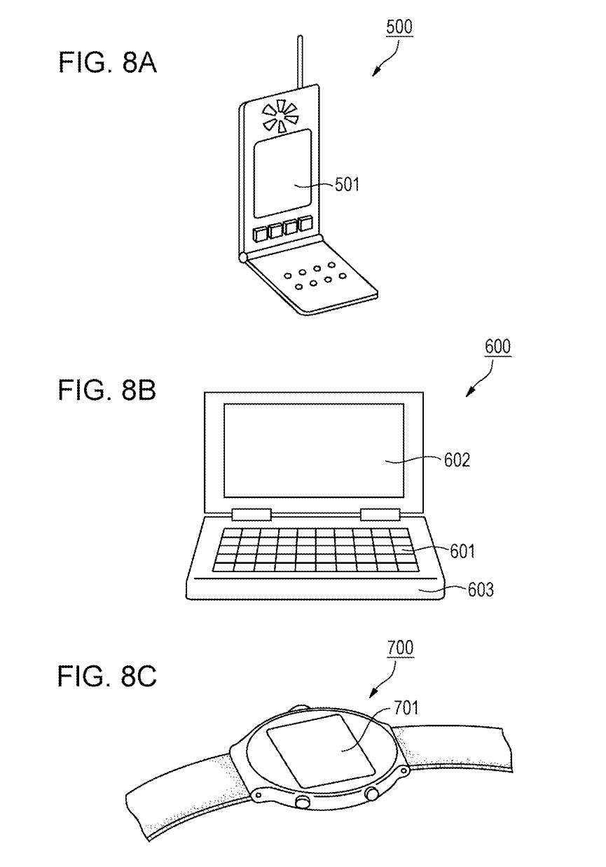

FIG. 8A is an oblique view illustrating an example of a mobile phone. A mobile phone illustrated in FIG. 8A includes a main body of the mobile phone 500, and the main body of the mobile phone 500 includes a liquid crystal display unit 501 using a liquid crystal device of the above-described embodiment.

FIG. 8B is an oblique view illustrating an example of a mobile information processing such as a word processor or a personal computer. The information processing device 600 includes an input device 601 such as a keyboard and a main body of the information processing device 603 having a liquid crystal display unit 602 using a liquid crystal device of the above-described embodiment as illustrated in FIG. 8B.

FIG. 8C is an oblique view illustrating an example of a wristwatch. The wristwatch illustrated in FIG. 8C includes a main body of the watch 700 and the main body of the watch 700 includes a liquid crystal display unit 701 using a liquid crystal device of the above-described embodiment.

As described above, a liquid crystal device of the above-described embodiment is applied to a display unit of each electronic apparatus illustrated in FIGS. 8A to 8C, so that image burn-in can be prevented and display qualities can be maintained for a long time.

The liquid crystal devices of the embodiments can be suitably used for electronic apparatuses in which improved light-resistance durability is required, for example, digital signage (electronic signage), a projector (a projection type liquid crystal display device), or the like in addition to the electronic apparatuses illustrated in FIGS. 8A to 8C. The invention can also be suitably applied to a liquid crystal device such as a liquid crystal lens or an optical pickup device using the liquid crystal lens.

### Projection Type Liquid Crystal Display Device

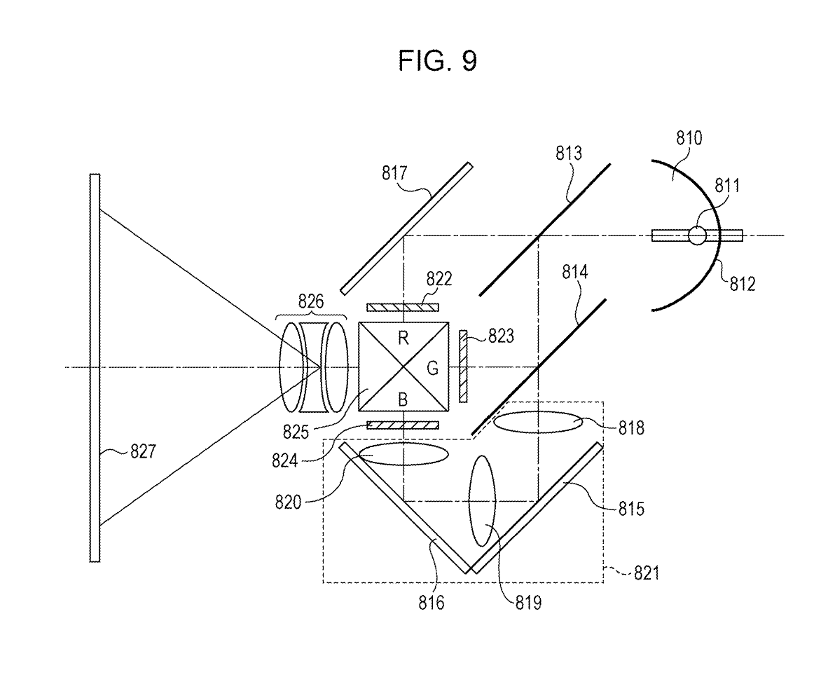

Configurations of projection type liquid crystal display devices (projectors) including liquid crystal devices of the above-described embodiments as optical modulation means will be described with reference to FIG. 9. FIG. 9 is a schematic configuration diagram illustrating a principal part of a projection display device using a liquid crystal device of the above-described embodiments as an optical modulation device.

A projection type liquid crystal display device illustrated in FIG. 9 includes a light source 810, dichroic mirrors 813 and 814, reflecting mirrors 815 and 816, 817, an incident lens 818, a relay lens 819, an outgoing lens 820, liquid crystal optical modulation devices 822, 823, and 824, a cross dichroic prism 825, and a projection lens 826.

The light source 810 includes a lamp 811 such as a metal halide lamp and a reflector 812 for reflecting light from the lamp. The dichroic mirror 813 transmits red light and reflects blue light and green light of a light beam from the light source 810. The transmitted red light is reflected by the reflecting mirror 817 and then enters the red-light liquid crystal optical modulation device 822 including the liquid crystal device of the above-described embodiments.

The green light of the color light reflected by the dichroic mirror 813 is reflected by the dichroic mirror 814 for reflecting green light and then enters the green-light liquid crystal optical modulation device 823 including a liquid crystal device, which is an example of the invention. The blue light also transmits the second dichroic mirror 814. In order to compensate for the difference of the blue light in the optical path length from the green light and the red light, a light guide unit 821 including a relay lens system containing the incident lens 818, the relay lens 819, and the outgoing lens 820 is provided, and the blue light enters the blue-light liquid crystal optical modulation device 824 including a liquid crystal device, which is an example of the invention, via the light guide unit 821.

The three color light components modulated by each optical modulation device enter the cross dichroic prism 825. The cross dichroic prism includes four rectangular prisms which are bonded together and includes a dielectric multilayer film for reflecting red light and a dielectric multilayer film for reflecting blue light arranged orthogonally on the inner surface of the prisms. The three color light components are combined by the dielectric multilayer films to form a light beam displaying a color image. The combined light beam is projected onto the screen 827 by the projection lens 826, which is a projection optical system, and an enlarged image is displayed.

In a projection display device having a structure as described above, a liquid crystal device of the above-described embodiment is applied to the liquid crystal optical modulation devices 822, 823, and 824, so that image burn-in can be prevented and display qualities can be maintained for a long period of time.

### EXAMPLES

The following Examples further clarify the effects of the invention. The invention is not limited to the examples below, and various changes can be made to carry out the invention without departing from the spirit of the invention.

In the examples, surface carbon concentrations of porous layers and internal carbon concentrations of porous layers were measured with respect to a liquid crystal device having an alignment layer formed by a liquid process and a liquid crystal device having an alignment layer formed by a vapor process.

Specifically, a liquid crystal panel was initially divided into a TFT array substrate and an opposing substrate, and then the liquid crystal was washed from the surface with hexane.

The TFT array substrate was then analyzed by ESCA (XPS) while being etched by Ar⁺ ion. A combined electron spectrometer from Thermo Electron Corporation was used for this analysis. An Al-Kα radiation source (1500 eV) was used. The detection angle was 90° and the spot size was 500 μmφ. The step size was 0.1 eV, the acquisition time was 100 μs, and pass energy was 20 eV. Sputtering was conducted at 3 kV/2 μA under a 1×10⁻⁷ Torr Ar atmosphere.

A concentration of C derived from the porous layer was calculated based on the total element concentration, which is 100%, of metal, for example Si, and O derived from the porous layer.

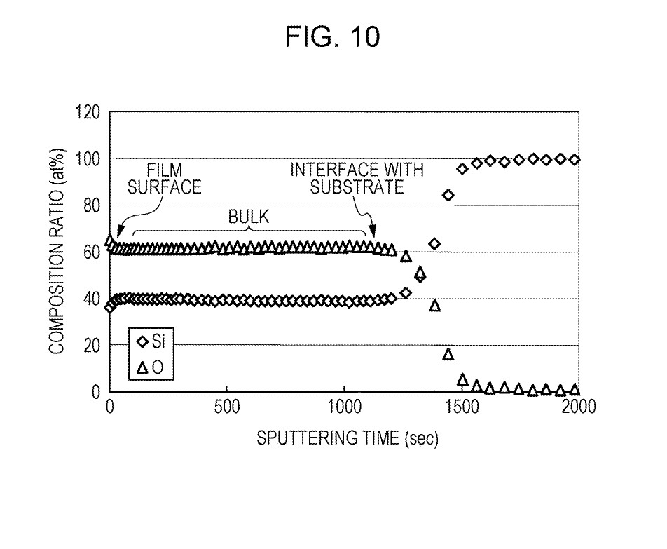

As illustrated in FIG. 10, sputtering time on the horizontal axis was plotted against composition ratio between metal and O on the vertical axis. Surface analysis was performed at the time of sputtering when the composition ratio was first to a composition ratio of bulk.

The average ratio of the internal carbon concentration of the porous layer was a quotient expressed as a percentage obtained by a calculation with the surface carbon concentration as the divisor and the bulk carbon concentration as the dividend. The average ratio of the internal fluorine concentration of the porous layer can be obtained by the same analysis except that C is replaced by F.

In the example, a SiO₂ film including pores, which is a porous layer, having an average pore size of 8 nm was formed by the oblique vapor deposition method, and the average pore size of the SiO₂ film including pores was then enlarged by etching to 20 nm.

The surface carbon concentrations of the porous layers and the internal carbon concentrations of the porous layers were measured in respect to the above-described liquid crystal device having the alignment layer formed by the liquid process and the above-described liquid crystal device having the alignment layer formed by the vapor process. The results are shown in Table 1. The ratios of the internal carbon concentrations of the porous layers to the surface carbon concentrations of the porous layers are collectively shown in parentheses in Table 1. In the example, results of measurement in the internal carbon concentration of the porous layer by D-SIMS are also collectively shown in Table 1.

TABLE 1

| | Liquid Phase | Vapor Phase |
|---|---|---|
| Surface Carbon Concentration | 4% | 2% |
| (Ar Sputter + ESCA) | | |
| Internal Carbon Concentration | 2 to 3% | ≦0.5% |
| (Ar Sputter + ESCA) | (50 to 75%) | (25%) |
| Internal Carbon Concentration | 11% | 8% |
| (D-SIMS) | | |

As shown in Table 1, the relative ratio of permeation of the organosilane compound into the porous layer can be determined by calculating the ratio of the internal carbon concentration of the porous layer to the surface carbon concentration of the porous layer.

Following is the reason why the carbon concentrations measured by ESCA and D-SIMS vary. The carbon concentration for ESCA may be lower as a result of a selective sputtering of C relative to Si or O during Ar-sputtering. In D-SIMS, converted values may be incorrect because the reference standard SiO₂ film, which is used for converting detected intensities into absolute carbon concentration values, is not an oblique vapor deposition film.

It is thus difficult to determine an absolute value of the surface carbon concentration (or the fluorine concentration) and the internal carbon concentration (or the fluorine concentration) of the porous layer 41 by each analysis method. The methods however enable the relative ratio of permeation of the organosilane compound (or the fluorine-containing organosilane compound) into the porous layer to be determined by specifying a ratio of the internal carbon concentration (or the fluorine concentration) of the porous layer to the surface carbon concentration (or the fluorine concentration) of the porous layer.

The above-described liquid crystal devices formed by the liquid process and by the vapor process were tested for alignment states and light resistance. For the alignment states, alignment states were observed with crossed nicols under an electrically energized condition. For light resistance, a mercury xenon lamp from HOYA CORPORATION was used as a light source. The test was specifically conducted in the following manner: the liquid crystal device (panel) was irradiated with a bandpass-filtered light having a wavelength of 250 nm to 400 nm. The light intensity of the light was 20 mW/cm² and the panel temperature was 35° C. during the test. An alignment defect was then observed in the liquid crystal device formed by the vapor process prior to the liquid crystal device formed by the liquid process.

The entire disclosure of Japanese Patent Application No. 2015-067302, filed Mar. 27, 2015 is expressly incorporated by reference herein.

What is claimed is:

1. A manufacturing method for a liquid crystal device including a liquid crystal layer held between a pair of substrates, the manufacturing method comprising the steps of:
forming a porous layer on at least one surface, which faces the liquid crystal layer, of the pair of substrates; and
forming an alignment layer on the porous layer, the alignment layer includes an organosilane compound,
wherein an internal carbon concentration of the porous layer is 20% or more based on a surface carbon concentration of the porous layer.

2. The manufacturing method for a liquid crystal device according to claim 1, wherein the step of forming the alignment layer including, applying a coating liquid onto the surface of the porous layer, the coating liquid includes the organosilane compound,
permeating the coating liquid into the porous layer by capillarity, and
baking the coating film.

3. The manufacturing method for a liquid crystal device according to claim 1, wherein the alignment layer is formed by vapor depositing the organosilane compound onto the porous layer.

4. A manufacturing method for a liquid crystal device including a liquid crystal layer held between a pair of substrates, the manufacturing method comprising the steps of:
forming a porous layer on at least one surface, which faces the liquid crystal layer, of the pair of substrates; and
forming an alignment layer on the porous layer, the alignment layer includes an organosilane compound,
wherein an internal fluorine concentration of the porous layer is 20% or more based on a surface fluorine concentration of the porous layer.

5. The manufacturing method for a liquid crystal device according to claim 4, wherein the step of forming the alignment layer including,
applying a coating liquid onto the surface of the porous layer, the coating liquid includes the fluorine-containing organosilane compound,
permeating the coating liquid into the porous layer by capillarity, and
baking the coating film.

6. The manufacturing method for a liquid crystal device according to claim 4, wherein the alignment layer is formed by vapor depositing the fluorine-containing organosilane compound onto the porous layer.

7. The manufacturing method for a liquid crystal device according to claim 1, wherein an average pore size is from 2 nm to 50 nm.

8. The manufacturing method for a liquid crystal device according to claim 1, wherein the porous layer is formed by an oblique vapor deposition method so as to have a column-shaped inorganic oxide film which has a pore between a plurality of columnar structures.

9. The manufacturing method for a liquid crystal device according to claim 1, wherein the porous layer including at least one of SiO₂, SnO₂, GeO₂, ZrO₂, TiO₂, or Al₂O₃.

10. A liquid crystal device including a liquid crystal layer held between a pair of substrates according to claim 1, the liquid crystal device comprising:
the porous layer formed on at least one surface, which faces the liquid crystal layer, of the pair of substrates; and
the alignment layer formed on the porous layer, the alignment layer includes the organosilane compound,
wherein the internal carbon concentration of the porous layer is 20% or more based on the surface carbon concentration of the porous layer.

11. A liquid crystal device including a liquid crystal layer held between a pair of substrates according to claim 4, the liquid crystal device comprising:
the porous layer formed on at least one surface, which faces the liquid crystal layer, of the pair of substrates; and
the alignment layer formed on the porous layer, the alignment layer includes the organosilane compound,
wherein an internal fluorine concentration of the porous layer is 20% or more based on the surface fluorine concentration of the porous layer.

12. An electronic apparatus comprising a liquid crystal device manufactured by the method according to claim 1.

13. An electronic apparatus comprising a liquid crystal device manufactured by the method according to claim 4.

14. An electronic apparatus comprising a liquid crystal device according to claim 10.

15. An electronic apparatus comprising a liquid crystal device according to claim 11.
